(19) United States
(12) Patent Application Publication
(10) Pub. No.: US 2022/0159382 A1
(43) Pub. Date: May 19, 2022

(54) Bone conduction speaker with a conductive damper

(71) Applicant: Dayun Zhu, Changde,Hunan (CN)

(72) Inventor: Dayun Zhu, Changde,Hunan (CN)

(21) Appl. No.: 17/425,955

(22) PCT Filed: Dec. 31, 2019
(86) PCT No.: PCT/CN2019/130721

§ 371 Date: Jul. 27, 2021

(30) Foreign Application Priority Data
Jan. 28, 2019 (CN) 201920148673.X

(51) Int. Cl. H04R 9/06; H04R 9/04

(52) U.S. Cl. CPC H04R 9/06; H04R 2460/13; H04R 2201/02; H04R 9/043

(57) ABSTRACT

A bone conduction speaker with a conductive damper includes an outer bracket and a U-yoke; a centre of the U-yoke forms a U-shaped groove; the U-shaped groove of the U-yoke has a magnet, a top of the magnet is provided with a spring washer; between the magnet and the U-yoke, there is an annular space; a top of the U-yoke is provided with an annular bracket, a top of the annular bracket is provided with a conductive damper; the conductive damper includes an outer circle, an inner circle and several connecting parts, the inner circle is fitted with a voice coil; a central position of the inner circle is fitted with a pillar, a middle of the pillar is provided with a round shrapnel, a top of the pillar is provided with a conduct piece; a periphery of the round shrapnel is fitted on the outer bracket.

### FIELD OF THE INVENTION

The present invention relates to speaker technical field, more particularly, to a bone conduction speaker with a conductive damper.

### BACKGROUND OF THE INVENTION

The method of sound conduction includes air vibrational conduction and bone conduction. The air vibrational conduction uses air vibration to transmit sound to the eardrum, and then through the eardrum to the inner ear nerve. Bone conduction is the transformation of sound into different frequencies of mechanical vibrations, transmitting sound waves through the human skull, bone loss, lymphatic transmission of an inner ear, helix, auditory nerve and auditory center.

The earphones using air vibrational conduction usually are plugged into the ears. Besides the sounds played by the earphones, other sounds are difficult to get into the ears. When users are in special situations, for example, crossing the road, they can not hear the whistle of cars, it is easy to cause dangerous accidents. In addition, the earphones using air vibrational conduction produce electromagnetic waves, which cause damage to the brain and hearing nerve. If the earphones are used for long periods and in many times, it will damage the user's eardrum, even cause tinnitus and seriously cause hearing loss. Compared with the earphones using air vibrational conduction, the earphones using bone conduction are closed to the ears, which eliminate many steps of sound wave transmission and can achieve clear sound restoration in noisy environments, and the sound waves will not affect others by diffusion in the air. Nowadays, the earphones using bone conduction becomes more and more widely used.

Chinese patent CN201420651297.3 discloses a bone conduction headphone, which consists of a main body, a headwear portion and a pair of plugs. The main body includes a plastic shell with metal decorative pieces on the surface of the sell and a moving coil oscillator in the shell. The voice coil of the moving coil oscillator is mounted on the fame through a damper. The damper is made from fiber, cloth, or rubber. The headwear portion is wearing on a neck or head and provided with a elastic part keeping it in shape. The elastic part is composed of a metal elastic piece which may be a sheet structure or a linear structure. In the bone conduction headphone disclosed in CN201420651297.3 the sound source stereo current signal flows through the voice circle, producing an alternating electromagnetic force, causing the relative movement between the voice circle and the magnet, and the damper produces deformation. Then, the induced vibration is conducted through the human skin and bone to directly transmit the sound wave to the auditory nerve.

However, the bone conduction headphone has the defects, such as unreasonable structure, low sensitivity, serious sound leakage and poor mechanical efficiency, and it can not meet the requirements of users.

### SUMMARY OF THE INVENTION

In order to overcome the defects of the prior art, the present invention provides a bone conduction speaker with a conductive damper, by cleverly setting the circle-shaped damper and a bracket, which greatly increases the vibration amplitude, improves the sensitivity and the mechanical efficiency of bone conduction.

The technical proposals of the present invention are as follows: a bone conduction speaker with a conductive damper includes an outer bracket and a U-yoke arranged in the outer bracket; a centre of the U-yoke forms a U-shaped groove in the cross-section; the U-shaped groove of the U-yoke has a magnet, a top of the magnet is provided with a spring washer; between the magnet and the U-yoke, there is an annular space; a top of the U-yoke is provided with an annular bracket, a top of the annular bracket is provided with a conductive damper; the conductive damper includes an outer circle, an inner circle and several connecting parts, the lower surface of the inner circle is provided with voice coil welding points, the outer circle is provided with wire welding points; the lower surface of the inner circle is fitted with a voice coil which is inserted into the annular space; a central position of an upper surface of the inner circle is fitted with a pillar, a middle of the pillar is provided with a round shrapnel, a top of the pillar is provided with a conductive piece; a periphery of the round shrapnel is fitted on the outer bracket.

A thickness of the conductive damper is between 0.05 mm-3.00 mm.

Several the connecting parts are evenly distributed between the inner circle and the outer circle, connecting the inner circle and the outer circle; the inner circle is provided with at least two voice coil welding points for fitting the voice coil; the outer circle is provided with at leas two wire welding points for fitting the power supply wire.

The voice coil welding points and the wire welding points are electrical conduction through copper foils; at least a part of the copper foils are arranged on the connecting parts.

Preferably, the outer circle is provided with one, two or more rings, adjacent the rings are connected by the connecting part.

At least one pair of the connecting parts are provided with the copper foils.

Each of the wire welding points is provided with a through hole used for assembling the power supply wire.

The outermost part of the outer circle extends at least one protrusion in the radial direction of the conductive damper, the protrusion passes through the outer bracket, and the wire welding point is disposed at a position on the protrusion outside the outer bracket.

The conductive damper includes a substrate layer, one end surface of the substrate layer is bonded with a first insulating layer with glue, the first insulating layer is bonded with a copper foil layer with glue, and the copper foil layer is bonded with a second insulating layer with glue; the first insulating layer coincides with the substrate layer; the copper foil layer and the second insulating layer coincides with a part or all of the substrate layer.

The substrate layer is made from manganese sheet, stainless steel, plastic, chemical material or fiber material.

The beneficial effects of the present invention are as follows:

By setting conductive damper and round shrapnel supporting the voice coil and the conductive piece, the bone conduction speaker with a conductive damper expands the amplitude, reduces power consumption and improves the mechanical efficiency of bone conduction.

In bone conduction speaker with a conductive damper, the voice coil and the power supply wire are electrical conduction by a conductive damper. It is not need the lead wire of the voice coil. Without the bother from a lead wire of the voice coil, the production process is optimized. The bone conduction speaker has no the problem that the lead wire can break due to the continuous work of the speaker, which improves the lifetime of the speaker. The conductive damper reduces the whole highness of the speaker so that the speaker can be small and thin.

The wire welding points of the conductive damper are disposed on, the outer circle, it is convenience for installing, the power supply wire. The wire does not need to bypass the conductive damper, does not vibrate with the conductive damper so as to avoiding the wire breaking and prolonging the lifetime of the speaker.

The wire welding points of the conductive damper extend out of the outer bracket through the protrusion so as to convenient for installing the wire, and optimize the production process.

With unfixed magnetic path, which is affected by the electromotive force of the voice coil, the voice coil bonding to the shrapnel can produce a stronger bass effect.

### BRIEF DESCRIPTION OF THE DRAWINGS

FIG. 1 shows a perspective view of the bone conduction speaker with a conductive damper according to the present invention.

FIG. 2 shows a perspective view of the conductive damper according to the present invention.

FIG. 3 shows a perspective view of the conductive damper in, the other embodiment according to the present invention.

FIG. 4 shows a perspective view of the conductive damper in another embodiment according to the present invention.

FIG. 5 shows a section view of the conductive damper with copper foils according to the present invention.

### EMBODIMENTS

In order to make the object of the present invention, the technical solution and the technical effect are more clear, and the present invention is further explained below in combination with specific embodiments. It should be understood that the specific embodiments described herein are used only for interpreting the invention and are not used to limit the invention.

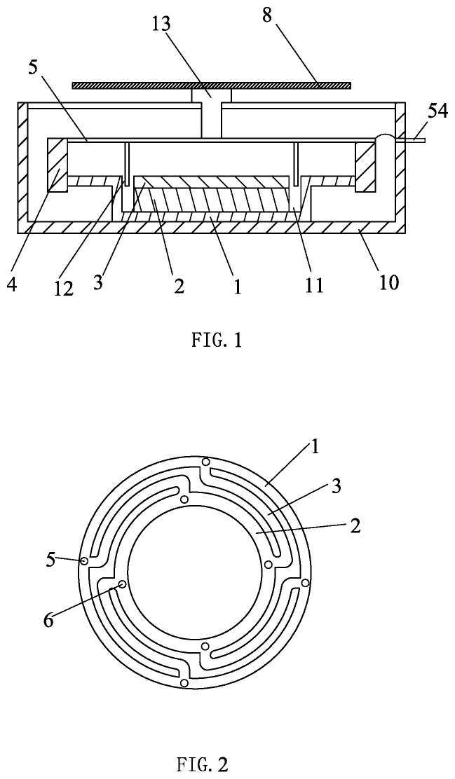

Referring to FIG. 1, A bone conduction speaker with a conductive damper includes an outer bracket 10 and a U-yoke 1 arranged in the outer bracket 10; a centre of the U-yoke 1 forms a U-shaped groove 11 in the cross-section; the U-shaped groove 11 of the U-yoke 1 has a magnet 2, a top of the magnet 2 is provided with a spring washer 3; between the magnet 2 and the U-yoke 1, there is an annular space 12; a top of the U-yoke 1 is provided with an annular bracket 4, a top of the annular bracket 4 is provided with a conductive damper 5; the conductive damper 5 covers U-shaped groove 11 of the U-yoke 1 and includes an outer circle 51, an, inner circle 52 and several connecting parts 53, the lower surface of the inner circle 52 is provided with voice coil welding points 54, the lower surface of the outer circle 51 is provided with wire welding points 55.

The lower surface of the inner circle 52 is fitted with a voice coil 7 which inserts the annular space 12; a central position of an upper surface of the inner circle 52 is fitted with a pillar 13, a middle of the pillar 13 is provided with a round shrapnel 6, a top of the pillar 13 is provided with a conductive piece 8; a periphery of the round shrapnel 6 is fitted on the outer bracket 10. In the bone conduction speaker with a conductive damper, when the conductive piece 8 transmits the vibration to the voice coil 7, the vibration is amplified through the conductive damper 5 and the round shrapnel 6 so as to increase the vibration amplitude of the voice oil 7, reduces power consumption and improves the mechanical efficiency of bone conduction. The outer bracket 10 can void the bone conduction speaker leaking sound.

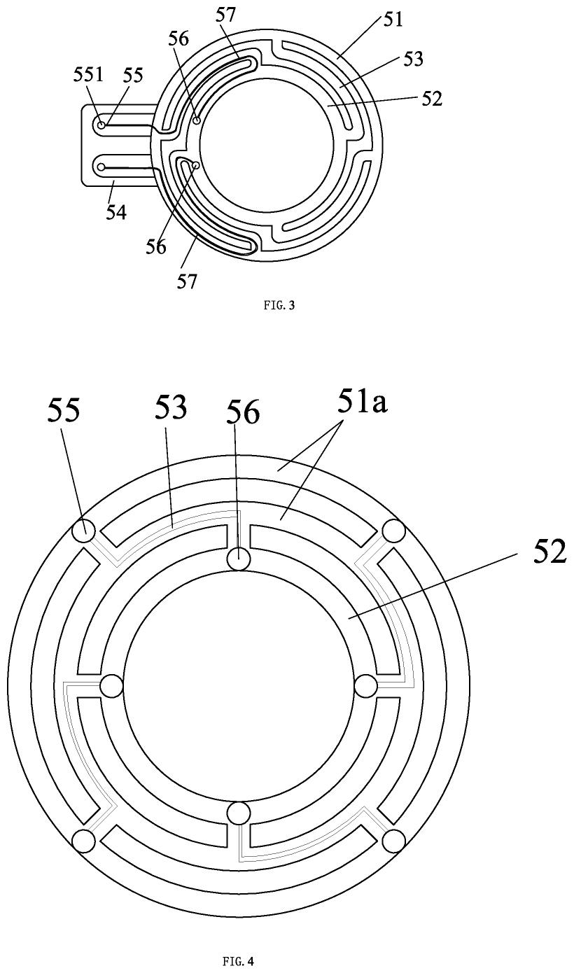

Referring to FIGS. 2, 3 and 4, in the conductive damper 5, the inner circle 53 locates in the outer circle 51. Several the connecting parts 53 evenly distributed between the outer circle 51 and the inner circle 52, and the head end and the tail end of each of the connecting parts 53 are respectively fixed on the outer circle 51 and the inner circle 52. With the hollow out structure, the thickness and the weight of the conductive damper are greatly reduced, which eliminates the traditional damper structure that requires concave and convex lines. The resonance of the conductive damper which is a very thin and very light and the voice coil improves the sound effect.

The outer circle 51 and the inner circle 52 are arranged pairs of wire welding points 55 and voice coil welding points 56. The wire welding points 55 and the voice coil welding points 56 are used to assemble the power supply wire. The wire welding points 5 are arranged on the outer circle 51, the voice coil welding points 56 are arranged on the inner circle 52. The wire welding points 55 and the voice coil welding points 56 are electrical conduction through copper foils 57, at least a part of the copper foils 57 are disposed on the connecting parts 53 and extends to the corresponding wire welding points 55 and the voice coil welding points 56 to realize electrical conductive. The voice coil and the power supply wire are electrical conductive through the conductive damper. The conductive damper is used in a speaker, it can avoid using a lead wire, so that the speaker does not need to provide vibration space for the lead wire, which greatly reduces the thickness of the speaker and avoids that the speaker loses sound because of the break of the lead wire, therefor improving the quality of the speaker.

Preferably, each of the wire welding points 55 is provided with a through hole 551 used for assembling the power supply wire, it is easy to install and highly efficient.

Referring to FIG. 2, preferably, when the speaker is small, the conductive damper requires only a circle of the ring 51a to meet the requirements; when the speaker is larger, the radiation of the conductive damper requires to be enlarged accordingly. Therefor, the outer circle 1 requires to be two or more rings 51a, and adjacent the rings 51a are connected by the connection parts 3.

Referring to FIG. 3, the outermost part of the outer circle 51 extends at least one protrusion 54 in the radial direction of the conductive damper, and the wire welding points 55 are disposed on the outer circle 1 or the protrusion 54, the power supply wire does not need to bypass the conductive damper so as to avoid the simultaneous vibration of the power supply wire and the conductive damper, prolong the service life of the power wire.

Preferably, the connecting parts 53 are straight or curve like S-shaped, ∫-shaped, W-shaped, M-shaped, and the like. It should be understood that the present invention does not define the shape of the connecting parts 53 as long as the object of the present invention can be achieved.

Preferably, the connecting parts 53 are provided as least two or more. It should be understand that the present invention does not define the number of the connecting parts 53 as long as the object of the present invention can be achieved. The connecting parts 53 are evenly arranged between the outer circle 51 and the inner circle 52 so that the vibration of the conductive damper are uniform and stable.

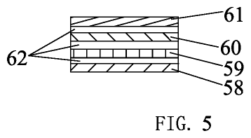

Preferably, referring to FIG. 5, the conductive damper 5 includes a substrate layer 58, one end surface of which is bonded with a first insulating layer 59 with glue 12, the first insulating layer 59 is bonded with a copper foil layer 60 with the glue 12, and the copper foil layer 60 is bonded with a second insulating layer 61 with the glue 12; the first insulating layer 69 coincides with the substrate layer 58; the copper foil layer 60 and the second insulating layer 61 coincide with part or all of the substrate layer 58.

Preferably, the substrate layer 58 is made from manganese sheet, stainless steel, plastic, chemical material or fiber material. The substrate layer 58 preferably is made from a manganese sheet, which has a high elastic limit and yield strength ratio, has excellent elastic properties, can absorb a lot of elastic energy without producing plastic deformation and also has a high fatigue limit and sufficient plasticity and toughness to prevent impact fracture.

Preferably, the thickness of the conductive damper is ranged in 0.05 mm˜3 mm.

The above content is a further detailed description of the present invention in combination with the specific preferred embodiments, and it cannot be determined that the specific embodiment of the present invention is limited to these descriptions. For those ordinary skilled in the technical art, the architectural form can be flexible and can derive a series of products without departing from the conception. Only a number of simple deductions or replacements shall be deemed to be within the scope of patent protection of the claims determined by the present invention.

1. A bone conduction speaker with a conductive damper, comprising, an outer bracket and a U-yoke; a centre of said U-yoke forms a U-shaped groove in a cross-section; said U-shaped groove of said U-yoke has a magnet, a top of said magnet is provided with a spring washer; between said magnet and said U-yoke, there is an annular space; a top of said U-yoke is provided with an annular bracket, a top of said annular bracket is provided with a conductive damper; said conductive damper includes an outer circle, an inner circle and several connecting parts, said lower surface of said inner circle is provided with voice coil welding points, said outer circle is provided with wire welding points; said lower surface of said inner circle is fitted with a voice coil which is inserted into said annular space; a central position of an upper surface of said inner circle is fitted with a pillar, a middle of said pillar is provided with a round shrapnel, a top of said pillar is provided with a conduct piece; a periphery of said round shrapnel is fitted on said outer bracket; said U-yoke, said annular bracket and said conductive damper are contained in said outer bracket.

2. The bone conduction speaker with said conductive damper according to claim 1, wherein a thickness of said conductive damper is ranged in 0.05 mm-3.00 mm.

3. The bone conduction speaker with conductive damper according to claim 1, wherein several said connecting parts are evenly distributed between said inner circle and said outer circle, connecting said inner circle and said outer circle; said inner circle is provided with at least two voice coil welding points for fitting said voice coil; said outer circle is provided with at leas two wire welding points for fitting said power supply wire.

4. The bone conduction speaker with said conductive damper according to claim 1, wherein said voice coil welding points and said wire welding points are electrical conduction through copper foils; at least a part of said copper foils are arranged on said connecting parts.

5. The bone conduction speaker with said conductive damper according to claim 1, wherein said outer circle is provided with one, two or more rings, adjacent said rings are connected by said connecting parts.

6. The bone conduction speaker with said conductive damper according to claim 1, wherein at least one pair of said connecting parts are provided with said copper foils.

7. The bone conduction speaker with said conductive damper according to claim 1, wherein each of said wire welding points is provided with a through hole used for assembling a power supply wire.

8. The bone conduction speaker with conductive damper according to claim 1, wherein the outermost part of said outer circle extends at least one protrusion in a radial direction of said conductive damper, said protrusion passes through said outer bracket, and one of said wire welding points is disposed at a position on said protrusion outside said outer bracket.

9. The bone conduction speaker with said conductive damper according to claim 1, wherein said conductive damper includes a substrate layer, one end surface of said substrate layer is bonded with a first insulating layer with glue, said first insulating layer is bonded with a copper foil layer with glue, and said copper foil layer is bonded with a second insulating layer with glue; said first insulating layer coincides with said substrate layer; said copper foil layer and said second insulating layer coincide with a part or all of said substrate layer.

10. The bone conduction speaker with said conductive damper according to claim 1, wherein said substrate layer is made from manganese sheet, stainless steel, plastic, chemical material or fiber material.
